(19) United States
(12) Patent Application Publication
(10) Pub. No.: US 2016/0235022 A1
(43) Pub. Date: Aug. 18, 2016

(54) SEED STARTER

(71) Applicant: Cody YEAGER, Nevada City, CA (US)

(72) Inventor: Cody YEAGER, Nevada City, CA (US)

(21) Appl. No.: 14/621,264

(22) Filed: Feb. 12, 2015

(51) Int. Cl. A01G 27/02

(52) U.S. Cl. CPC A01G 27/02

(57) ABSTRACT

A seed-growing apparatus is disclosed. The seed-growing apparatus can comprise at least a first reservoir configured to contain a first liquid. The seed-growing apparatus can also comprise at least a first seed pod, the first seed pod including a first surface having a first permeability. The first surface can be configured to be in contact with the first liquid when the first reservoir contains the first liquid.

### FIELD OF THE DISCLOSURE

This relates generally to a seed starter that can provide optimal growing conditions for germinating seeds.

### BACKGROUND OF THE DISCLOSURE

Gardeners, such as home gardeners, often attempt to grow seedlings from seeds. Practicing this method of gardening can enhance the gardener's overall sense of accomplishment, and can be more cost-effective than purchasing established seedlings and/or plants, which can be more expensive than seeds.

Growing seedlings from seeds can be one of the most challenging aspects of gardening; particularly growing seedlings that are healthy enough for future transplantation. Seeds can require extremely precise environmental conditions to germinate. Further, once plants have germinated, ensuring strong, healthy root development, and an overall hearty plant for transplantation into an outdoor environment, for example, can be yet another challenge presented to a gardener.

Current methods of germinating seeds in a pot or other closed-wall container can have a low germination success rate (i.e., a low ratio of seeds successfully germinated and ready for transplantation to total seeds planted). This low success rate can cause a home gardener to be unsure as to how to provide correct soil characteristics for the seeds to achieve successful germination. The most important soil characteristics can be the moisture content and temperature of the soil, both of which can present problems if not regularly attended to (e.g., if the gardener is away from home for any extended period of time).

While many professional gardeners have studied and have become familiar with the proper moisture levels and temperatures for a growing medium (e.g., soil) for germinating seeds, and may have the time to dedicate to regularly monitor the moisture of the soil, the average home gardener may not have such knowledge and/or time. Currently, there are devices on the market that allow a home gardener to provide water to seeds/seedlings at relatively infrequent intervals of time to try to address the home gardener's relative lack of time to provide proper soil moisture. These existing devices differ in their systems and methods for delivering the water to the seeds/seedlings, and do not completely resolve all complications relating to the maintenance of ideal soil moisture content for seedlings planted within a container.

What is needed is an easy-to-use, reliable device for generating multiple seedlings from seeds that provides and maintains the proper growing medium conditions for seed germination and growth, with little required time and effort from home gardeners.

### SUMMARY OF THE DISCLOSURE

A seed-growing apparatus is described that includes one or more seed pods and one or more reservoirs for holding a liquid. The seed pods can be made of a permeable or porous material such that the liquid can flow through the seed pod walls into a growing medium that can be contained within the seed pods—the growing medium can house seeds or seedlings, for example. The liquid flow rate through the seed pod walls can be designed to provide optimal growing conditions for the seeds or seedlings in the growing medium. In some examples, the permeability or porosity of the seed pod walls can be such that the roots of the seeds or seedlings can themselves regulate the flow rate of the liquid through the seed pod walls.

### BRIEF DESCRIPTION OF THE DRAWINGS

FIG. 1 illustrates an exemplary seed starter according to examples of the disclosure.

FIG. 2 illustrates another exemplary seed starter according to examples of the disclosure.

FIG. 3 illustrates another exemplary seed starter according to examples of the disclosure.

FIG. 4 illustrates an exemplary media player seed starter according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

A seed-growing apparatus is described that includes one or more seed pods and one or more reservoirs for holding a liquid. The seed pods can be made of a permeable or porous material such that the liquid can flow through the seed pod walls into a growing medium that can be contained within the seed pods—the growing medium can house seeds or seedlings, for example. The liquid flow rate through the seed pod walls can be designed to provide optimal growing conditions for the seeds or seedlings in the growing medium. In some examples, the permeability or porosity of the seed pod walls can be such that the roots of the seeds or seedlings can themselves regulate the flow rate of the liquid through the seed pod walls.

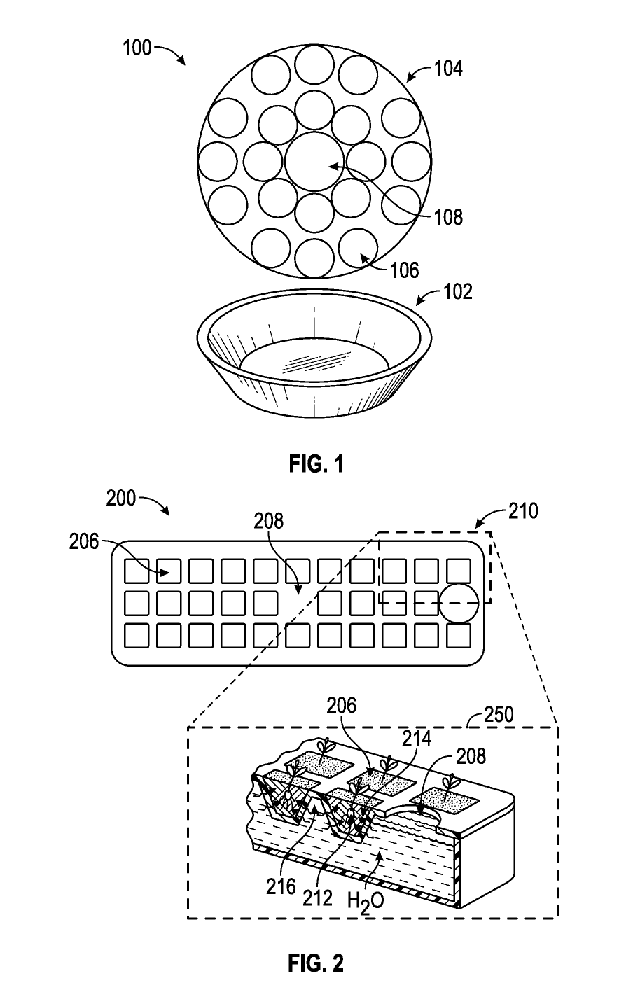

FIG. 1 illustrates exemplary seed starter 100 according to examples of the disclosure. Seed starter 100 can include lower portion 102 and upper portion 104. Lower portion 102 can be shaped such that the lower portion can hold a certain amount of water or other liquid for use by seed starter 100. For example, lower portion 102 can be shaped like a bowl or a reservoir.

Upper portion 104 can be placed on upper of lower portion 102 when seed starter 100 is fully assembled. Upper portion 104 can include multiple seed pods 106. Seed pods 106 can be cavities in upper portion 104 of various sizes that can hold seeds, soil, and any other growing medium for use in growing seedlings from seeds. Seed pods 106, when upper portion 104 is placed on top of lower portion 102 holding water (or another liquid), can draw water from the lower portion into the seed pods and the growing medium inside the seed pods (this will be discussed in more detail with reference to FIG. 2). In this way, water can automatically be provided to the growing medium inside seed pods 106 to allow for seedling development from seeds. Upper portion 104 can also include fill hole 108 through which lower portion 102 can be filled with water (or another liquid) when the upper portion is seated on the lower portion.

Seed pods 106 can have various shapes and sizes that can be optimized for the type of seeds to be grown in the seed pods. For example, for large/medium-sized seeds that require more soil space to sprout and root, approximate preferred dimensions for seed pods 106 can be 1⅜″ W×1½″ W×1¾″ D. These dimensions may be increased depending on the size and shape of the container (e.g., lower portion 102) in which seed pods 106 will be placed. It is understood that the above dimensions are exemplary only, and do not limit the scope of the disclosure.

As another example, for small/medium-sized seeds that require less soil space to sprout and root, approximate preferred dimensions for seed pods 106 can be 1¼″ W×1½″ W×1¼ D. As above, these dimensions may be increased depending on the size and shape of the container (e.g., lower portion 102) in which seed pods 106 will be placed. Further, as above, it is understood that the above dimensions are exemplary only, and do not limit the scope of the disclosure. In some examples, seed starter 100 can include seed pods 106 having different dimensions, such that different seed pods can be designed or optimized for different growing conditions. In some examples, lower portion 102 can be split into two or more reservoirs that can hold different types of liquid, such that different ones of seed pods 106 can be fed with different liquids for different growing conditions. In some examples, the liquids in the two or more reservoirs can be the same type of liquid. In some examples, each seed pod 106 can have its own dedicated reservoir of liquid.

In some commercial applications (or in situations in which a relatively large number of seeds are to be germinated—for example, 100+ seeds), the depth of seed pods 106 may be increased relative to the dimensions provided above. This increased depth can ensure that all (or most) of the seeds are able to become rooted, as different seeds can mature at different rates. Those seeds that are further along in the maturation process can required excess root space or a faster water (or liquid) flow rate towards the bottom of the seed pod to ensure adequate water delivery to protect against becoming root-bound, while the other seeds in the other seed pods further mature. It is understood that the above-discussed dimensions are exemplary only, and do not limit the scope of the disclosure—different seeds and seedlings can be well-suited for seed pods of different sizes.

Additionally, though the discussion in the disclosure focuses on growing seedlings from seeds using seed pods 106, it is understood that the seed pods can be used in other applications as well. For example, seeds starter 100 can be used for starting and rooting plant stem cuttings. The above problems identified with respect to maintaining proper soil moisture for growing seedlings from seeds can be similar to the problem of maintaining proper soil moisture for rooting stem cuttings—thus, the seed starter of the disclosure can similarly be designed and used to root stem cuttings in accordance with the examples of the disclosure.

FIG. 2 illustrates another exemplary seed starter 200 according to examples of the disclosure. Seed starter 200 can include seed pods 206 and fill hole 208, similar to as described with reference to seed starter 100 in FIG. 1. One or more aspects of seed starter 100 can similarly be included in seed starter 200—those details will not be repeated here for brevity.

FIG. 2 also illustrates cross-sectional view 250 of seed starter 200 at location 210. As illustrated in cross-sectional view 250, seed pods 206 can include seeds/seedlings 212 in growing media 214 (e.g., soil). Seeds/seedlings 212 can be at different stages of maturation; in the embodiment illustrated, the seeds/seedlings can have developed roots. Seed starter 200 can include reservoir 216 of water (or other liquid). The water (or other liquid) 216 can be in contact with the walls of seed pods 206, and can be drawn into growing media 214 through the walls of the seed pods to provide moisture to the growing media. The walls of seed pods 206 can be appropriately porous so as to provide the proper amount of water (or other liquid) to growing media 214, and thus to seeds/seedlings 212.

The walls of seed pods 206 can be formed using any type of porous material, the porosity of which can be selected to provide optimal liquid flow for the seeds/seedlings in any application. For example, the walls of seed pods 206 can be formed of polyethylene (including high-density polyethylene and low-density polyethylene), polypropylene, polytetrafluoroethylene, polyvinylidene fluoride, ethyl vinyl acetate and polystyrene. Other materials can be concrete or clay. In some examples, the porosity of the walls of seed pods 206 can be approximately 10%-15%. In some examples, the porosity/permeability of the walls of seed pods 206 can differ from one seed pod to another across seed starter 200, such that different seed pods can be designed or optimized for different growing conditions.

In some examples, the permeability of the walls of seed pods 206 can be maximally 1*10⁴ cm³/min at 35 cm WC. In some examples, a minimum permeability of the walls of seed pods 206 can be selected so as to allow for sufficiently effective operation of seed starter 200 with a variety of common soil mixtures. Soil mixtures can encompass different types of soil mixtures and texture additives that can be used to either increase or decrease drainage and aeration of the soil mixture depending on the needs of any plants that may be growing in the soil mixture. Such soil mixtures can include soil mixtures that can create their own nutrients naturally, and also soil-less potting mixtures. Soil-less potting mixtures can allow plants to be grown in a variety of organic and inorganic materials. A gardener can use these mixtures as a sterile base to avoid soil-bound diseases and pests that can sometimes breed and live within soil. Some soil-less growing media can include peat moss, perlite, vermiculite, bark, coconut coir and sand. Generally, these media can be mixed together rather than used alone, as each can provide its own function which can affect the overall moisture and aeration of the plant root zone. Fertilizers can also be added to the above mixes, providing important nutrients that soil-less mixtures can lack. Soil-less components can be added to soil mixtures improve the overall texture, drainage and aeration of the soil mixture. The maximum and/or minimum permeability of the walls of seed pods 206 can be selected so as to substantially match the drainage characteristics of the soil (or growing medium) contained within the seed pods.

When seed pods 206 are placed in contact with water (e.g., when the walls of the seed pods are placed in contact with water), and a growing medium (e.g., soil) in the seed pods is in contact with the walls of the seed pods, the portions of the growing medium closest to the seed pod walls can contain more moisture than the parts of the growing medium that are further away from the seed pod walls. As a result, the roots of seeds/seedlings 212 can be stimulated to approach the seed pod 206 walls, and can also absorb the moisture at the seed pod walls. As a result of the absorbed moisture, further moisture can be pulled into growing medium 214 through the walls, and thus the amount of moisture pulled through seed pod 206 walls can be increased and regulated by the presence of roots at the walls.

Once root hairs from the roots come into contact with seed pod 206 walls, the amount of liquid flow through the walls can depend on a balance between the porosity of the walls and the surrounding growing medium 214, as well as the amount of moisture absorbed by the roots themselves. The amount of moisture absorbed by the roots can be determined by the needs of the seeds/seedlings 212. Thus, the flow of liquid or moisture into growing medium 214 through the seed pod 206 walls can be automatically controlled by the seeds/seedlings 212 themselves, and can thus provide optimal moisture content for the seeds/seedlings. In some examples, it can be beneficial to select the permeability of the seed pod 206 walls that, on its own, would provide relatively low water flow into the seed pods, but with the help of the roots pulling the water through the walls, can provide sufficient water for the seeds/seedlings to grow without oversaturating the growing medium. In other words, the water flow rate of the seed pod 206 walls on their own can be less than the water flow needs of the seeds/seedlings.

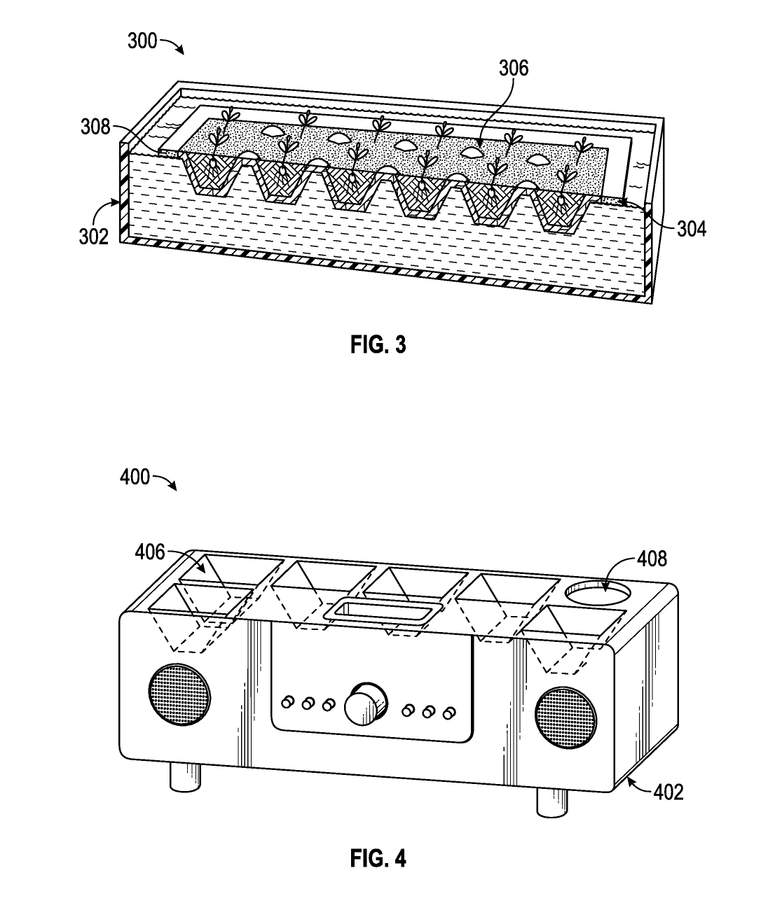

FIG. 3 illustrates another exemplary seed starter 300 according to examples of the disclosure. Seed starter 300 can include lower portion 302 and upper portion 304. Lower portion 302 can include a reservoir to store water (or other liquid) for use in seed starter 300. Upper portion 304 can include seed pods 306, which can include seeds/seedlings and one or more growing media (e.g., soil) in which the seeds/seedlings can grow. Upper portion 304 and/or seed pods 306 can be made of a porous material to allow for liquid flow into or out of the seed pods, as described above. One or more aspects of seed starter 100 and seed starter 200 can similarly be incorporated into seed starter 300—those details will not be repeated here for brevity.

Upper portion 304 can be configured to be buoyant so as to float on the liquid that lower portion 302 contains. For example, upper portion 304 can be surrounded by a buoyant material 308 (e.g., foam) at the edges of the upper portion, or at selected locations around the edges of the upper portion. As another example, upper portion 304 can itself be manufactured to be buoyant. As a result, upper portion 304 can automatically rise or fall based on the water level in lower portion 302, and thus seed pods 306 can at all times remain substantially fully submerged in the water. This can ensure consistent water flow into and out of seed pods 306 as the water level in lower portion 302 changes (whether due to consumption by the seeds/seedlings, evaporation, or any other cause). It is understood that the exact seed starter 300 configuration illustrated is exemplary only, and that other seed starter configurations in which seed pods 306 can rise and fall with a water level in a reservoir are also within the scope of the disclosure.

The seed starter of the disclosure can be integrated into many different types of enclosures. FIG. 4 illustrates exemplary media player seed starter 400 according to examples of the disclosure. Media player seed starter 400 can include seed pods 406 integrated with media player 402. Media player 402 can be, for example, an MP3 media player that can include a docking port with which an MP3 media player can be docked. One or more aspects of seed starters 100, 200 and 300 can similarly be implemented in media player seed starter 400—those details will not be repeated here for brevity. For example, media player seed starter 400 can include a reservoir for water (or other liquid) to feed seed pods 406. It is understood that the seed starter of the disclosure can alternatively be integrated with devices other than a media player, such as furniture (e.g., tables), electronics, appliances, etc.

In some examples, the reservoirs of seed starters 100, 200, 300 and/or 400 can be directly filled with water (e.g., using a watering can or water hose). In some examples, the reservoirs can be automatically filled with water by relying on condensation. For example, the seed starters can include one or more fans (in some examples, solar-powered fans) that can force air over various hydrophilic and hydrophobic coatings on the seed starter/seed starter reservoir, which can lead to condensation of water on those coatings and filling of the seed starter reservoir. In some examples, the reservoirs of the seed starters can be connected to a self-regulating filling device, such as an olla. These ollas can automatically feed water into the reservoirs of the seeds starters as the water is consumed, thus ensuring that sufficient water always exists in the seed starters to successfully grows seedlings. These examples are exemplary only, and it is understood that many other variations of the seed starters of the disclosure are contemplated.

Therefore, according to the above, some examples of the disclosure are directed to a seed-growing apparatus comprising: at least a first reservoir configured to contain a first liquid; and at least a first seed pod, the first seed pod including a first surface having a first permeability, wherein the first surface is configured to be in contact with the first liquid when the first reservoir contains the first liquid. Additionally or alternatively to one or more of the examples disclosed above, in some examples, the first reservoir is included in a lower portion of the seed-growing apparatus, and the first seed pod is included in an upper portion of the seed-growing apparatus, and the lower portion and the upper portion are configured to fit together. Additionally or alternatively to one or more of the examples disclosed above, in some examples, the first seed pod is configured to be buoyant on the first liquid in the first reservoir such that the first surface remains in contact with the first liquid as a level of the first liquid in the first reservoir changes. Additionally or alternatively to one or more of the examples disclosed above, in some examples, the first seed pod is configured to have a shape and comprise a material such that the first seed pod itself is buoyant on the first liquid. Additionally or alternatively to one or more of the examples disclosed above, in some examples, the first seed pod is coupled to a flotation device configured to be buoyant on the first liquid. Additionally or alternatively to one or more of the examples disclosed above, in some examples, the first surface is configured to allow the first liquid to flow through the first surface from an outside of the first seed pod to an inside of the first seed pod. Additionally or alternatively to one or more of the examples disclosed above, in some examples, the first permeability is matched to a drainage characteristic of a growing medium that the first seed pod is configured to contain. Additionally or alternatively to one or more of the examples disclosed above, in some examples, the first seed pod comprises a porous material. Additionally or alternatively to one or more of the examples disclosed above, in some examples, the seed-growing apparatus further comprises a second seed pod, the first seed pod and the second seed pod having different dimensions. Additionally or alternatively to one or more of the examples disclosed above, in some examples, the seed-growing apparatus further comprises a second seed pod including a second surface having a second permeability, different from the first permeability. Additionally or alternatively to one or more of the examples disclosed above, in some examples, the seed-growing apparatus further comprises: a second reservoir configured to contain a second liquid; and a second seed pod including a second surface, wherein the second surface is configured to be in contact with the second liquid when the second reservoir contains the second liquid. Additionally or alternatively to one or more of the examples disclosed above, in some examples, the first liquid is a different liquid than the second liquid.

Some examples of the disclosure are directed to a method of manufacturing a seed-growing apparatus, the method comprising: forming at least a first reservoir configured to contain a first liquid; and forming at least a first seed pod, the first seed pod including a first surface having a first permeability, wherein the first surface is configured to be in contact with the first liquid when the first reservoir contains the first liquid. Some examples of the disclosure are directed to a seed-growing apparatus comprising: means for containing a first liquid; and means for containing a seed and permeating the first liquid to the seed when the means for containing the seed is in contact with the first liquid.

As described above, the examples of the disclosure provide one or more ways in which a computing system can provide a recommended physical location to a user at which the user can complete an activity that was initiated at another location. Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

We claim:

1. A seed-growing apparatus comprising:
at least a first reservoir configured to contain a first liquid; and
at least a first seed pod, the first seed pod including a first surface having a first permeability,
wherein the first surface is configured to be in contact with the first liquid when the first reservoir contains the first liquid.

2. The seed-growing apparatus of claim 1, wherein the first reservoir is included in a lower portion of the seed-growing apparatus, and the first seed pod is included in an upper portion of the seed-growing apparatus, and the lower portion and the upper portion are configured to fit together.

3. The seed-growing apparatus of claim 1, wherein the first seed pod is configured to be buoyant on the first liquid in the first reservoir such that the first surface remains in contact with the first liquid as a level of the first liquid in the first reservoir changes.

4. The seed-growing apparatus of claim 3, wherein the first seed pod is configured to have a shape and comprise a material such that the first seed pod itself is buoyant on the first liquid.

5. The seed-growing apparatus of claim 3, wherein the first seed pod is coupled to a flotation device configured to be buoyant on the first liquid.

6. The seed-growing apparatus of claim 1, wherein the first surface is configured to allow the first liquid to flow through the first surface from an outside of the first seed pod to an inside of the first seed pod.

7. The seed-growing apparatus of claim 1, wherein the first permeability is matched to a drainage characteristic of a growing medium that the first seed pod is configured to contain.

8. The seed-growing apparatus of claim 1, wherein the first seed pod comprises a porous material.

9. The seed-growing apparatus of claim 1, further comprising a second seed pod, the first seed pod and the second seed pod having different dimensions.

10. The seed-growing apparatus of claim 1, further comprising a second seed pod including a second surface having a second permeability, different from the first permeability.

11. The seed-growing apparatus of claim 1, further comprising:
a second reservoir configured to contain a second liquid; and
a second seed pod including a second surface,
wherein the second surface is configured to be in contact with the second liquid when the second reservoir contains the second liquid.

12. The seed-growing apparatus of claim 11, wherein the first liquid is a different liquid than the second liquid.

13. A method of manufacturing a seed-growing apparatus, the method comprising:
forming at least a first reservoir configured to contain a first liquid; and
forming at least a first seed pod, the first seed pod including a first surface having a first permeability,
wherein the first surface is configured to be in contact with the first liquid when the first reservoir contains the first liquid.

14. A seed-growing apparatus comprising:
means for containing a first liquid; and
means for containing a seed and permeating the first liquid to the seed when the means for containing the seed is in contact with the first liquid.
